(19) United States
(12) Patent Application Publication
(10) Pub. No.: US 2025/0035938 A1
(43) Pub. Date: Jan. 30, 2025

(54) PROJECTION SUBSTRATE AND SMART GLASSES

(71) Applicant: Cellid, Inc., Tokyo (JP)

(72) Inventors: Tatsuo INABATA, Tokyo (JP); Susumu TATEOKA, Tokyo (JP); Toshiaki SHOZU, Tokyo (JP); Satoshi SHIRAGA, Tokyo (JP)

(73) Assignee: Cellid, Inc., Tokyo (JP)

(21) Appl. No.: 18/918,020

(22) Filed: Oct. 16, 2024

Related U.S. Application Data
(63) Continuation of application No. PCT/JP2022/018243, filed on Apr. 20, 2022.

(51) Int. Cl. G02B 27/01; F21V 8/00

(52) U.S. Cl. CPC G02B 27/0172; G02B 6/0016; G02B 2027/0178

(57) ABSTRACT

A projection substrate including: an incident region that guides a projection light to a splitting region; a splitting region that includes a first diffraction grating that guides the projection light to an emission region; and the emission region that includes a second diffraction grating that emits the projection light from a second surface, wherein a ratio of the width of a convex portion to a period of a concave-convex portion of the first diffraction grating differs depending on a distance to the incident region.

### CROSS-REFERENCE TO RELATED APPLICATIONS

The present application is a continuation application of International Application number PCT/JP2022/018243, filed on Apr. 20, 2022, contents of which are incorporated herein by reference in their entirety.

### BACKGROUND OF THE INVENTION

The present disclosure relates to a projection substrate and smart glasses. Conventionally, an eyeglass-type device, a head mounted display, and the like have been known for displaying two-dimensional images to be observed by a user, utilizing an optical system including a waveguide and the like (for example, refer to Japanese Unexamined Patent Publication No. 2017-207686).

Since such devices incorporate the optical system into limited space, the optical system may become complicated. In addition, if a simple optical system is used, luminance of the images projected in a display region may vary.

### BRIEF SUMMARY OF THE INVENTION

The present disclosure focuses on these points, and its object is to reduce variation in luminance of a projection image to be observed by a user with a simple configuration.

A first aspect of the present disclosure provides a projection substrate for projecting an image light onto a second surface while transmitting at least a part of light that entered from a first surface to the second surface opposite to the first surface, the projection substrate including: an incident region into which a projection light for projecting the image light enters; a splitting region that includes a first diffraction grating that guides the projection light that has entered from the incident region; and an emission region that includes a second diffraction grating that emits a part of the projection light that has entered from the second surface after guiding the part of the projection light entered from the splitting region, wherein the incident region guides the incident projection light to the splitting region, the splitting region diffracts the part of the projection light toward the emission region, the first diffraction grating includes a plurality of first concave-convex portions, each composed of a first convex portion and a first concave portion, that are formed so as to repeat in a first direction in which the projection light is guided, the splitting region includes a plurality of first divided regions, and a first fill factor which is a ratio of a width of the first convex portion in the first direction to a length corresponding to a first period, which is a period of the first concave-convex portion in one first divided region, is within a range that does not include a predetermined value, and a first fill factor of a first divided region which is closer to the incident region than the one first divided region is within a range that includes the predetermined value.

A second aspect of the present disclosure provides smart glasses that are worn by a user, the smart glasses including: the projection substrate according to the first aspect, which is provided as at least one of a lens for the right eye or a lens for the left eye of the user, and projects the image light onto the second surface, while transmitting at least a part of light entering from the first surface to the eyes of the user; a frame that fixes the projection substrate; and a projection part that is provided in the frame and radiates the projection light, for projecting the image light to the emission region onto the incident region of the projection substrate.

### BRIEF DESCRIPTION OF THE DRAWINGS

FIG. 1 shows a configuration example of smart glasses 10 according to the present embodiment.

FIG. 2 shows an outline of an optical path of a projection light in the smart glasses 10 according to the present embodiment.

FIG. 3 shows an outline of the optical path of the projection light in a projection substrate 100 according to the present embodiment.

FIG. 4 shows an example of a projection light which is radiated from a projection part 120 according to the present embodiment to the projection substrate 100, and an image light emitted from the projection substrate 100.

FIG. 5 shows a configuration example of the projection substrate 100 according to the present embodiment.

FIG. 6 is a diagram for explaining a first fill factor.

FIG. 7A is simulation results when the first fill factor of a first reflection region 226 is 0.4.

FIG. 7B is simulation results when the first fill factor of the first reflection region 226 is 0.5.

FIG. 7C is simulation results when the first fill factor of the first reflection region 226 is 0.6.

FIG. 7D is simulation results when the first fill factor of the first reflection region 226 is 0.85.

FIG. 8 shows a variation example of the smart glasses 10 according to the present embodiment.

### DETAILED DESCRIPTION OF THE INVENTION

Hereinafter, the present disclosure will be described through exemplary embodiments, but the following exemplary embodiments do not limit the invention according to the claims, and not all of the combinations of features described in the exemplary embodiments are necessarily essential to the solution means of the invention.

### <Configuration Example of Smart Glasses 10>

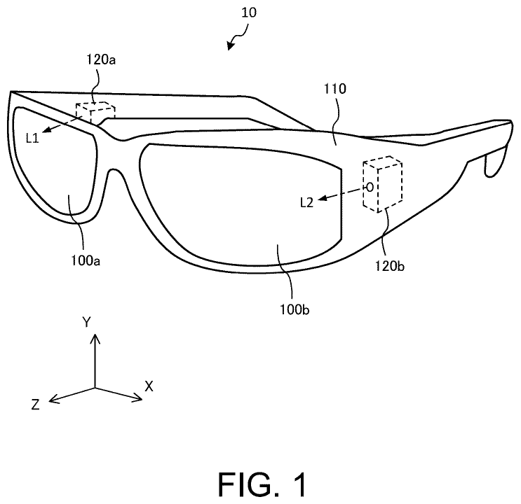

FIG. 1 shows a configuration example of smart glasses 10 according to the present embodiment. In this embodiment, three mutually orthogonal axes are designated as the X-axis, Y-axis, and Z-axis. The smart glasses 10 are a wearable device worn by a user, for example. The smart glasses 10 project an image light onto a display region provided on a projection substrate 100 while having a user observe a view through glasses. The smart glasses 10 include the projection substrate 100, a frame 110, and a projection part 120.

The projection substrate 100 projects the image light onto a second surface while transmitting at least a part of the light entering from a first surface to the eyes of the user. Here, the first surface of the projection substrate 100 is a surface facing the side opposite to the user when the user is wearing the smart glasses 10. The second surface of the projection substrate 100 is a surface facing the user when the user is wearing the smart glasses 10. FIG. 1 shows an example in which the first surface and the second surface of the projection substrate 100 are disposed approximately parallel to an XY plane. The projection substrate 100 is a glass substrate on which a diffraction grating, functioning as a waveguide, is formed, for example. The projection substrate 100 will be described later.

The frame 110 fixes the projection substrate 100. The frame 110 is provided with the projection substrate 100 as at least one of a lens for the right eye or a lens for the left eye of the user. FIG. 1 shows an example in which a projection substrate 100a is provided as the lens for the right eye of the user on the frame 110, and a projection substrate 100b is provided as the lens for the left eye.

Alternatively, the frame 110 may be provided with one projection substrate 100 as the lens for the right eye or the lens for the left eye of the user. Further, the frame 110 may be provided with one projection substrate 100 as a lens for both eyes of the user. In this case, the frame 110 may have a goggle shape. The frame 110 has parts such as a temple, a strap, and the like so that the user can wear the smart glasses 10.

The projection part 120 is provided in the frame 110 and radiates the projection light, for causing the image light to be projected onto the projection substrate 100, toward the projection substrate 100. The frame 110 is provided with one or a plurality of such projection parts 120. FIG. 1 shows an example in which (i) a projection part 120a for irradiating a projection substrate 100a with a projection light L1 and (ii) a projection part 120b for irradiating a projection substrate 100b with a projection light L2 are provided in the frame 110.

The projection part 120 may be provided at a portion of the frame 110 to which the projection substrate 100 is fixed, or may be provided in the temple or the like of the frame 110. The projection part 120 is preferably provided integrally with the frame 110. For example, the projection part 120 radiates a projection light including one wavelength onto the projection substrate 100, allowing the user to observe a monochrome image. Further, the projection part 120 may radiate the projection substrate 100 with a projection light including a plurality of wavelengths, allowing the user to observe an image including multiple colors.

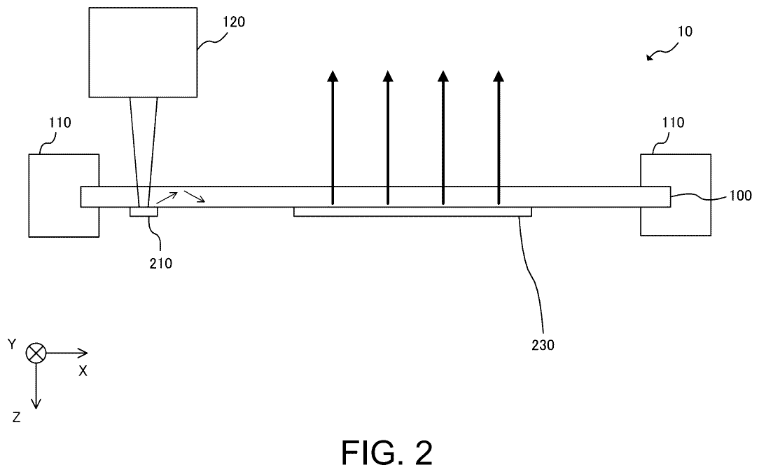

FIG. 2 shows an outline of an optical path of a projection light in the smart glasses 10 according to the present embodiment. The projection part 120 radiates the projection light onto an incident region 210 provided on the projection substrate 100. The incident region 210 guides the projection light into a substrate of the projection substrate 100. Then, the projection substrate 100 emits the projection light guided into the substrate as an image light from an emission region 230. The incident region 210 and the emission region 230 will be described later.

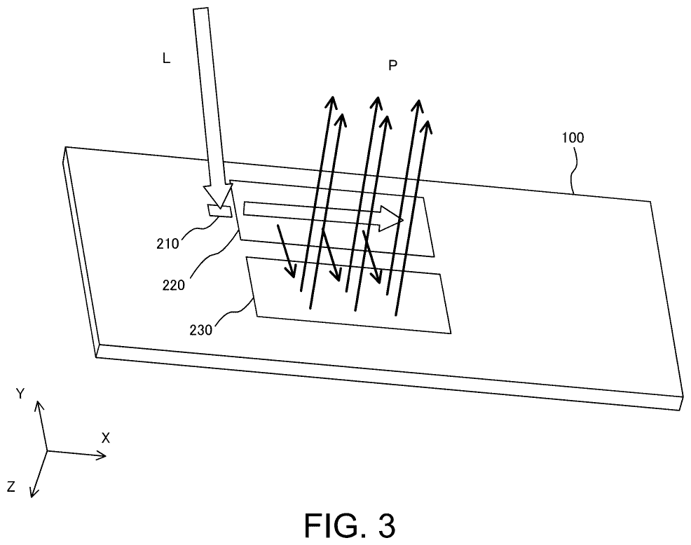

FIG. 3 shows an outline of an optical path of a projection light in the projection substrate 100 according to the present embodiment. As will be described later, the projection substrate 100 includes the incident region 210, a splitting region 220, and the emission region 230. A projection light L enters the incident region 210 and is emitted from the emission region 230 through the splitting region 220 as an image light P. The splitting region 220 guides the projection light L to the emission region 230, part by part, as the projection light L travels away from the incident region 210.

Similarly, as the projection light L travels away from the splitting region 220, the emission region 230 also emits portions of the projection light L as part of the image light P. By doing this, the projection substrate 100 emits, as the image light P, the projection light L incident on the incident region 210 from the emission region 230.

Here, an example is conceived of in which the splitting region 220 guides the projection light L to the emission region 230 at a constant rate throughout the entire region of the splitting region 220. In this case, since the quantity of the projection light L decreases as the projection light L travels away from the incident region 210, the intensity of the projection light L entering the emission region 230 from the splitting region 220 may differ depending on a distance from the incident region 210.

Similarly, an example is conceived of in which the emission region 230 emits, as the image light P, the projection light L at a constant rate throughout the entire region of the emission region 230. In this case, since the quantity of the projection light L decreases as the projection light L travels away from the splitting region 220, the intensity of the image light P emitted from the emission region 230 may differ depending on a distance from the incident region 210 and a distance from the emission region 230. For example, luminance may gradually decrease from the upper left pixels to the lower right pixels of an image projected by the emission region 230. The projection substrate 100 according to the present embodiment reduces such variations in the luminance.

### <Example of the Projection Light and Image Light>

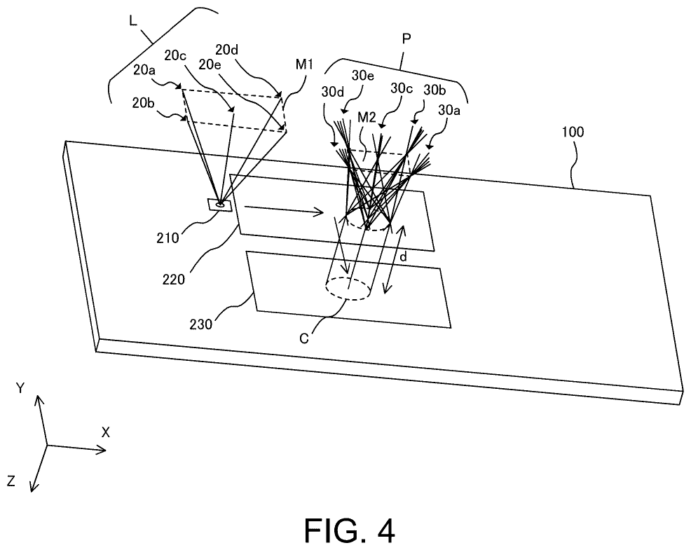

FIG. 4 shows an example of the projection light L radiated from the projection part 120 to the projection substrate 100 and the image light P emitted from the projection substrate 100 according to the present embodiment. For example, the projection part 120 radiates the projection light L toward the second surface of the projection substrate 100 positioned in the Z direction. The projection light L corresponds to an image to be shown to the user, and for example, when a screen or the like is installed on a plane approximately parallel to the XY plane and the projection light L is projected thereon, an image M1 to be observed by the user is displayed on that screen. The image to be shown to the user is an AR (Augmented Reality) image or a VR (Virtual Reality) image generated by a processor included in the projection part 120, for example. In this way, the projection part 120 radiates, as the projection light L, a plurality of light rays forming the image M1 on the plane approximately parallel to the XY plane.

In this embodiment, an example in which the projection part 120 projects an approximately rectangular image M1, whose longitudinal direction is the X-axis direction on the plane, approximately parallel to the XY plane will be described. In FIG. 4, five light rays, from among the plurality of light rays radiated by the projection part 120, are shown as input light rays 20. For example, a light ray corresponding to the upper left pixels of the image is a first input light ray 20a, a light ray corresponding to the lower left pixels of the image is a second input light ray 20b, a light ray corresponding to the center pixels of the image is a third input light ray 20c, a light ray corresponding to the upper right pixels of the image is a fourth input light ray 20d, and a light ray corresponding to the lower right pixels of the image is a fifth input light ray 20e.

For example, the projection part 120 irradiates the incident region 210 of the projection substrate 100 with such projection light L so as to form an upright virtual image at infinity or at a predetermined position. The projection light incident on the incident region 210 passes through the splitting region 220 and is emitted from the emission region 230 as the image light P. The image light P is emitted from the emission region 230 and enters the user's eyes, which are at a distance d from the projection substrate 100. The image light P forms an image M2 on the retina of the user's eyes. In this way, the image light P includes a plurality of light fluxes that form the image M2.

In FIG. 4, five light fluxes, from among a plurality of light fluxes which are radiated from a circular region C of the emission region 230 of the projection substrate 100 and formed into an image at a predetermined position, are shown as output light fluxes 30. For example, a light flux formed into an image as the lower right pixels of the image M2 is designated as a first output light flux 30a, a light flux formed into an image as the upper right pixels of the image M2 is designated as a second output light flux 30b, a light flux formed into an image as the center pixels of the image M2 is designated as a third output light flux 30c, a light flux formed into an image as the lower left pixels of the image M2 is designated as a fourth output light flux 30d, and a light flux formed into an image as the upper left pixels of the image M2 is designated as a fifth output light flux 30e.

Each light flux corresponds to one of the plurality of input light rays 20 entering from the projection part 120. For example, the first output light flux 30a corresponds to the first input light ray 20a, and the first output light flux 30a includes a plurality of light rays generated by a plurality of splittings, diffractions, and the like of the first input light ray 20a that take place from the incident region 210 to the emission region 230 of the projection substrate 100. Similarly, the second output light flux 30b corresponds to the second input light ray 20b, the third output light flux 30c corresponds to the third input light ray 20c, the fourth output light flux 30d corresponds to the fourth input light ray 20d, and the fifth output light flux 30e corresponds to the fifth input light ray 20e.

In other words, the image M2, which is the image light P emitted from the emission region 230 and formed on the retina of the user's eyes, corresponds to the image M1 projected with the projection light L radiated by the projection part 120. In this way, the user wearing the smart glasses 10 can perceive the image M2 as if it were projected onto the second surface of the projection substrate 100, superimposed on a view seen through the projection substrate 100. In other words, the emission region 230 functions as the display region for displaying the image M2 corresponding to the image M1 projected with the projection light L.

In FIG. 4, the image M2 observed by the user is an image obtained by inverting the image M1 projected with the projection light L vertically and horizontally. The image M1 projected with the projection light L may be a still image, or instead, may be a moving image. The projection substrate 100 that emits the image light P corresponding to the incident projection light L will now be described.

### <Configuration Example of the Projection Substrate 100>

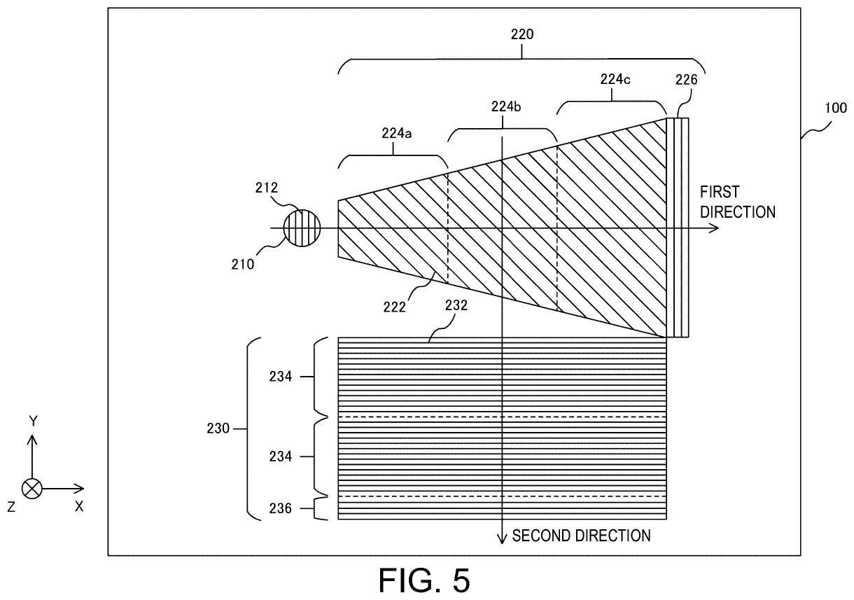

FIG. 5 shows a configuration example of the projection substrate 100 according to the present embodiment. FIG. 5 shows an example in which the first surface and the second surface of the projection substrate 100 are disposed approximately parallel to the XY plane. The projection substrate 100 is a substrate for projecting the image light onto the second surface, which is the opposite side of the first surface, while transmitting at least a part of the light that entered from the first surface to the second surface. The projection substrate 100 is a glass substrate, for example. The projection substrate 100 includes the incident region 210, the splitting region 220, and the emission region 230.

### <Example of the Incident Region 210>

A projection light for projecting an image light enters the incident region 210, and the incident region 210 guides the incident projection light toward the splitting region 220. FIG. 5 shows an example in which the incident region 210 has a circular shape in a plane approximately parallel to the XY plane, but the present disclosure is not limited thereto. The incident region 210 may have a shape such as an ellipse, a polygon, or a trapezoid, as long as it can guide the projection light to the splitting region 220.

The incident region 210 includes a diffraction grating in which a plurality of first grooves 212 are formed with an IPE (Input Pupil Expander) period. In other words, the plurality of first grooves 212 are arranged on the upper surface of the projection substrate 100 in the same direction with a predetermined groove width and interval, thereby functioning as the diffraction grating. The incident region 210 has a reflective or transmissive diffraction grating and guides the projection light in a direction of the splitting region 220 through reflective or transmissive diffraction.

The IPE period of the plurality of first grooves 212 is in a range of about 10 nm to about 10 μm, for example. The IPE period is preferably in a range of about 100 nm to about 1 μm. The IPE period is more preferably in the range of about 200 nm to about 800 nm. The depth of the plurality of first grooves 212 is in a range of about 1 nm to about 10 μm. The depth of the plurality of first grooves 212 is preferably in a range of about 50 nm to about 800 nm.

The fill factor of the plurality of first grooves 212 is in a range of about 0.05 to about 0.95. The fill factor of the plurality of first grooves 212 is preferably in a range of about 0.3 to about 0.7. Here, the fill factor is a value obtained by dividing a distance between two adjacent first grooves 212 by the IPE period. The distance between two adjacent first grooves 212 may be referred to as a “line”, the width of the first groove 212 may be referred to as a “space”, and the IPE period may be referred to as a “pitch”. In this case, the pitch is the sum of the line and the space, and the fill factor is a value obtained by dividing the line by the pitch.

The plurality of first grooves 212 are arranged in a direction from the incident region 210 toward the splitting region 220, for example. Here, the traveling direction of the projection light from the incident region 210 toward the splitting region 220 is referred to as a first direction. FIG. 5 shows an example in which the first direction is a direction approximately parallel to the X-axis direction, and the first grooves 212 extending in a direction approximately parallel to the Y-axis direction are arranged in the first direction. Since the projection light converges as it enters the incident region 210, the incident region 210 guides the projection light to the splitting region 220 such that the projection light spreads out at a divergence angle centered on the first direction within the plane of the projection substrate 100.

### <Example of the Splitting Region 220>

The splitting region 220 guides a part of the projection light that entered from the incident region 210 toward the emission region 230. The splitting region 220 is provided in a region through which the projection light passes, in the plane approximately parallel to the XY plane. The splitting region 220 has a reflective diffraction grating, and guides the projection light toward the emission region 230 through the reflective diffraction. The splitting region 220 has a rectangular shape whose longitudinal direction is the first direction, for example.

Since the projection light travels while spreading out around the first direction, it is preferable for the splitting region 220 to have a shape that widens as the distance from the incident region 210 increases, diverging from the first direction, which is a traveling direction of the projection light passing through the incident region 210. The splitting region 220 has a trapezoidal shape, a fan shape, or the like in the plane approximately parallel to the XY plane, for example. FIG. 5 shows an example in which the splitting region 220 has the trapezoidal shape. A splitting region 220 with such a shape can be formed to correspond to a region where the projection light spreads while travelling in the XY plane, and can efficiently guide the projection light.

In the splitting region 220, a plurality of first concave-convex portions, each composed of a first convex portion and a first concave portion, are formed to repeat in the first direction. Hereinafter, the first concave-convex portions are referred to as second grooves 222. That is, the splitting region 220 includes a first diffraction grating in which a plurality of second grooves 222 are formed with a first period. In other words, the plurality of second grooves 222 are arranged on the upper surface of the projection substrate 100 in the same direction with a predetermined groove width and interval, thereby functioning as the diffraction grating. The splitting region 220 functions as, for example, a reflective diffraction grating, and guides the projection light to the emission region 230.

The first period of the plurality of second grooves 222 is different from the IPE period of the plurality of first grooves 212. As the first period, it is desirable to select an appropriate period for guiding the projection light to the emission region 230. The first period is, for example, in a range of about 10 nm to about 10 μm. The first period is preferably in a range of about 50 nm to about 1 μm. The first period is more preferably in a range of about 100 nm to about 700 nm. The depth of the plurality of second grooves 222 is in a range of about 1 nm to about 10 μm. The depth of the plurality of second grooves 222 is preferably in a range of about 5 nm to about 800 nm.

The plurality of second grooves 222 are arranged in a predetermined direction, for example. For example, a direction from the splitting region 220 toward the emission region 230 is defined as a second direction, and an angle formed between the first direction and the second direction is defined as a first angle. In this case, the plurality of second grooves 222 are formed in a direction inclined toward the second direction by an angle of 12 of the first angle with respect to the first direction. FIG. 5 shows an example in which the second direction is a direction approximately parallel to the Y-axis direction, the first angle is approximately 90 degrees, and the plurality of second grooves 222 are arranged in the direction inclined toward the second direction by approximately 45 degrees with respect to the first direction.

The splitting region 220 includes a plurality of first divided regions 224 arranged in the traveling direction of the incident projection light. The second grooves 222 formed in the plurality of first divided regions 224 have different depths. In other words, in the splitting region 220, the second grooves 222 are formed such that a ratio of light guided to the emission region 230 within the incident projection light varies for each of the first divided regions 224.

The splitting region 220 preferably includes three or more first divided regions 224. The first period of the plurality of second grooves 222 formed in each of the plurality of first divided regions 224 is, for example, the same for all. In this way, the splitting region 220 is divided into the plurality of first divided regions 224, thereby varying the quantity of projection light guided to the emission region 230 for each of the first divided regions 224. By doing this, the distribution of the quantity of light in a direction perpendicular to the traveling direction of the projection light is adjusted to be approximately constant, while guiding the projection light with different intensities, depending on the distance from the incident region 210, to the emission region 230.

For example, the second grooves 222 are formed in such a way that the depth of the second groove 222 provided in one of the first divided regions 224 is greater than the depth of the second groove 222 provided in the first divided region 224, which is closer to the incident region 210 than that particular divided region 224. In this case, the rate of change of depth of the second grooves 222 of two adjacent first divided regions 224 among the plurality of first divided regions 224 may increase as the distance from the incident region 210 increases.

As an example, a splitting region 220 having three first divided regions 224, as shown in FIG. 5, is considered. Here, it is assumed that a second groove 222 is formed with a depth such that the second groove 222 guides light with approximately ¼ of the quantity of the projection light incident on a first divided region 224a to the emission region 230 in the first divided region 224a, which is closest to the incident region 210 among the three first divided regions 224. In this case, approximately ¾ of the remaining quantity of the projection light incident on the first divided region 224a, which is closest to the incident region 210, enters an adjacent first divided region 224b.

It is assumed that the second groove 222 is formed with a depth such that the second groove 222 guides light with approximately ⅓ of the quantity of the projection light incident on the first divided region 224b to the emission region 230 in the first divided region 224b, which is second closest to the first divided region 224. In other words, the depth of the second groove 222 of the first divided region 224b, which is second closest to the incident region 210, is greater than the depth of the second groove 222 of the first divided region 224a, so as to guide light having 4/3 times the quantity of light compared to the first divided region 224a, which is closest to the incident region 210, to the emission region 230. The first divided region 224b guides light with approximately ¼ of the quantity of the projection light incident on the first divided region 224a, which is closest to the incident region 210, to the emission region 230.

Then, approximately ½ of the remaining quantity of the projection light incident on the first divided region 224a, which is closest to the incident region 210, enters an adjacent first divided region 224c. It is assumed that the second groove 222 is formed with a depth such that the second groove 222 guides light with approximately ½ of the quantity of the projection light incident on the first divided region 224c to the emission region 230 in the first divided region 224c, which is third closest to the incident region 210. In other words, the depth of the second groove 222 of the first divided region 224c, which is third closest to the incident region 210, is greater than the depth of the second groove 222 of the first divided region 224b, so as to guide light having 3/2 times the quantity of light compared to the first divided region 224b, which is closest to the incident region 210, to the emission region 230.

In addition, the second grooves 222 of the two adjacent first divided regions 224 among the three first divided regions 224 are formed in such a way that the rate of change of depth of these second grooves 222 increases as the distance from the incident region 210 increases. Then, the first divided region 224c, which is third closest to the incident region 210, guides light with approximately ¼ of the quantity of the projection light incident on the first divided region 224a, which is closest to the incident region 210, to the emission region 230. As seen in the above example, it can be understood that by adjusting the quantity of the projection light to be guided to the corresponding emission region 230 for each of the first divided regions 224 to a predetermined value, the splitting region 220 can guide the projection light to the emission region 230 while ensuring approximately constant distribution of the quantity of the projection light guided to the respective emission regions 230.

The splitting region 220 may further include a first reflection region 226, which is one of the first divided regions 224, at a position farthest from the incident region 210. FIG. 5 shows an example in which the splitting region 220 includes three first divided regions 224 and the first reflection region 226. The first reflection region 226 reflects at least a part of the light that has passed through the plurality of first divided regions 224 to the plurality of first divided regions 224 again. The first reflection region 226 includes second grooves 222 of greater depth than the depth of the second grooves 222 of the adjacent first divided region 224.

For example, it is desirable that the depth of the second grooves 222 of the first reflection region 226 is about three times or more the depth of the second grooves 222 having the largest depth among the second grooves 222 of the plurality of first divided regions 224. It is more desirable that the depth of the second grooves 222 of the first reflection region 226 is about ten times or more the depth of the second grooves 222 having the greatest depth of the second grooves 222 among the second grooves 222 of the plurality of first divided regions 224. The second grooves 222 of the first reflection region 226 may be arranged in the first direction.

Since the splitting region 220 includes such a first reflection region 226, the plurality of first divided regions 224 guide at least a part of the light reflected by the first reflection region 226 to the emission region 230. In this way, the splitting region 220 can guide more projection light to the emission region 230. The depth of the second grooves 222 of the plurality of first divided regions 224 may be determined such that the quantity of projection light guided to the emission region 230 from each of the first divided regions 224, incorporating the reflected light from the first reflection region 226, is approximately constant.

The widths of the convex portion and the concave portion of each of the plurality of first divided regions 224 are formed so that a first fill factor reaches a predetermined value. The first fill factor is a ratio of the width of the first convex portion in the first direction to the first period of the second grooves 222 of one first divided region 224.

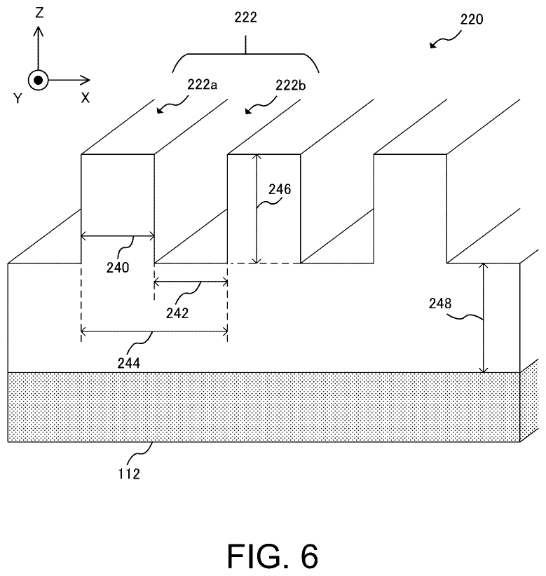

FIG. 6 is a diagram for explaining the first fill factor. The plurality of second grooves 222 are formed on the glass substrate 112. A line 240 is the width of a first convex portion 222a of the second groove 222. A space 242 is the width of a first concave portion 222b of the second groove 222. A pitch 244 is the sum of the line 240 and the space 242, and is the length of the first period. The first fill factor is the line 240 divided by the pitch 244. A length 248 from the first concave portion 222b to the glass substrate 112 is in a range of 10 nm or more and 500 nm or less. The length 248 is preferably in a range of 30 nm or more and 200 nm or less. A depth 246 is the depth of the second groove 222.

The first fill factor of the first reflection region 226, which is one of the first divided regions 224, is within a range that does not include a predetermined value. The predetermined value is 0.5, for example. As a specific example, the first fill factor of the first reflection region 226 is within a range of 0.35 or less or 0.65 or more, excluding the predetermined value 0.5. The first fill factor of the first divided region 224, which is closer to the incident region 210 than the first reflection region 226, is within the range including the predetermined value of 0.5. As a specific example, the first fill factors of the first divided region 224a, the first divided region 224b, and the first divided region 224c are in a range of 0.3 or more and 0.7 or less.

The greater the absolute value of a difference between the depth of the second grooves 222 of the first reflection region 226 and the depth of the second grooves 222 of the first divided region 224c, the smaller the absolute value of a difference between the first fill factor of the first reflection region 226 and the first fill factor of the first divided region 224c, which is closer to the incident region 210 than the first reflection region 226. For example, when the difference between the depth of the second grooves 222 of the first reflection region 226 and the depth of the second groove 222 of the first divided region 224c is 180 nm, the difference between the first fill factor of the first reflection region 226 and the first fill factor of the first divided region 224c, which is closer to the incident region 210 than the first reflection region 226, is 0.35. On the other hand, when the difference between the depth of the second grooves 222 of the first reflection region 226 and the depth of the second grooves 222 of the first divided region 224c is 680 nm, the difference between the first fill factor of the first reflection region 226 and the first fill factor of the first divided region 224c, which is closer to the incident region 210 than the first reflection region 226, is 0.30.

### <Example of the Emission Region 230>

The emission region 230 guides at least a part of the projection light that entered from the splitting region 220 and emits that part of the projection light as an image light from the second surface of the projection substrate 100. FIG. 5 shows an example in which the emission region 230 has a rectangular shape whose longitudinal direction is the X-axis direction in a plane approximately parallel to the XY plane, but the present disclosure is not limited thereto. The emission region 230 may have a rectangular shape, a square shape, a trapezoid shape, or the like whose longitudinal direction is the Y-axis direction, as long as the emission region 240 can guide the projection light and emit it as the image light.

In the emission region 230, a plurality of third grooves 232, which are a plurality of second concave-convex portions each composed of a second convex portion and a second concave portion, are formed to repeat in the second direction. That is, the emission region 230 includes a second diffraction grating in which the plurality of third grooves 232 are formed with a second period. In other words, the plurality of third grooves 232 are arranged on the upper surface of the projection substrate 100 in the same direction with a predetermined groove width and interval, thereby functioning as the diffraction grating. The emission region 230 has a reflective or transmissive diffraction grating and guides the image light toward the user's eye through reflective or transmissive diffraction.

The second period of the plurality of third grooves 232 provided in the emission region 230 is different from the first period of the plurality of second grooves 222 in the splitting region 220. The second period of the plurality of third grooves 232 in the emission region 230 may be the same as the IPE period of the plurality of first grooves 212 in the incident region 210. By making the period of the diffraction grating provided in the incident region 210 into which the projection light enters and the period of the diffraction grating provided in the emission region 230 where the image light is emitted coincide with each other in this manner, it is possible to reduce distortion or the like occurring in an image observed by the user.

The second period is formed in a range of about 10 nm to about 10 μm, for example. The second period is preferably formed in a range of about 100 nm to about 1 μm. The second period is more preferably formed in a range of about 200 nm to about 800 nm. The depth of the plurality of third grooves 232 is formed in a range of about 1 nm to about 10 μm. The depth of the plurality of third grooves 232 is preferably formed in a range of about 5 nm to about 800 nm.

The plurality of third grooves 232 are arranged in the second direction, which is the direction from the splitting region 220 toward the emission region 230, for example. FIG. 5 shows an example in which the third grooves 232 extending in the first direction are arranged in the second direction.

Similarly to the splitting region 220, the emission region 230 includes a plurality of second divided regions 234 arranged in the traveling direction of the projection light that entered from the splitting region 220. The third grooves 232 formed in the plurality of second divided regions 234 have different depths. In other words, in the emission region 230, the third grooves 232 are formed such that a ratio of light which will be emitted as the image light within the incident projection light varies for each of the second divided regions 234.

The emission region 230 preferably includes two or more second divided regions 234. For example, the third groove 232 provided in one of the second divided regions 234 is assumed to have a depth greater than the depth of the third groove 232 provided in the second divided region 234, which is closer to the splitting region 220 than that particular second divided region 234. Further, when the emission region 230 includes three or more second divided regions 234, the rate of change of depth of the third grooves 232 of two adjacent second divided regions 234 may increase as the distance from the splitting region 220 increases. The second period of each of the plurality of third grooves 232 is, for example, the same for all.

As described above, the emission region 230 is divided into the plurality of second divided regions 234, resulting in variations in the quantity of light emitted as image light for each of the second divided regions 234. In this way, similarly to the plurality of first divided regions 224 of the splitting region 220, by guiding the projection light as the image light, the emission region 230 can adjust the distribution of the quantity of light across the entire image to be approximately constant when observed by an observer as an image.

The emission region 230 may further include a second reflection region 236, which is one of the second divided regions 234, at a position farthest from the splitting region 220. FIG. 5 shows an example in which the emission region 230 includes two second divided regions 234 and the second reflection region 236. The second reflection region 236 reflects at least a part of the light that has passed through the plurality of second divided regions 234, to the plurality of second divided regions 234 again. The second reflection region 236 includes third grooves 232 of greater depth than the third grooves 232 of the adjacent second divided region 234.

For example, it is desirable that the depth of the third groove 232 of the second reflection region 236 is about three times or more the depth of the third grooves 232 having the largest depth among the third grooves 232 of the plurality of second divided regions 234. It is more desirable that the depth of the third grooves 232 of the second reflection region 236 is about ten times or more the depth of the third grooves 232 having the largest depth among the third grooves 232 of the plurality of second divided regions 234.

Since the emission region 230 includes such a second reflection region 236, the plurality of second divided regions 234 emit, as the image light, at least a part of the light reflected by the second reflection region 236 from the second surface of the projection substrate 100. In this way, the emission region 230 can emit more projection light as the image light, similarly to the splitting region 220. The depth of the third grooves 232 of the plurality of second divided regions 234 may be determined such that the quantity of light emitted as the image light from each of the second divided regions 234, incorporating the reflected light from the second reflection region 236, is approximately constant.

The widths of the convex portion and the concave portion of each of the plurality of second divided regions 234 are formed so that a second fill factor reaches a predetermined value. The second fill factor is a ratio of the width of the second convex portion in the second direction to the second period of the third groove 232.

The second fill factors of a second divided region 234a, a second divided region 234b, and a second divided region 234c are within a range that includes the predetermined value. The predetermined value is, for example, 0.5. As a specific example, the second fill factors of the second divided region 234a, the second divided region 234b, and the second divided region 234c are in a range of 0.3 or more and 0.7 or less, including the predetermined value of 0.5.

The second fill factor of the second reflection region 236 is within a range that does not include the predetermined value 0.5. For example, the second fill factor of the second reflection region 236 is 0.35 or less or 0.65 or more, but is not limited thereto.

Further, the greater the absolute value of a difference between the depth of the third groove 232 of the second reflection region 236 and the depth of the third groove 232 of the second divided region 234, the smaller the absolute value of a difference between the second fill factor of the second reflection region 236 and the second fill factor of the second divided region 234. For example, when the difference between the depth of the third groove 232 of the second reflection region 236 and the depth of the third groove 232 of the second divided region 234 is 70 nm, the difference between the second fill factor of the second reflection region 236 and the second fill factor of the second divided region 234, which is closer to the splitting region 220 than the second reflection region 236, is 0.1. On the other hand, when the difference between the depth of the third groove 232 of the second reflection region 236 and the depth of the third groove 232 of the second divided region 234 is 470 nm, the difference between the second fill factor of the second reflection region 236 and the second fill factor of the second divided region 234, which is closer to the splitting region 220 than the second reflection region 236, is 0.00.

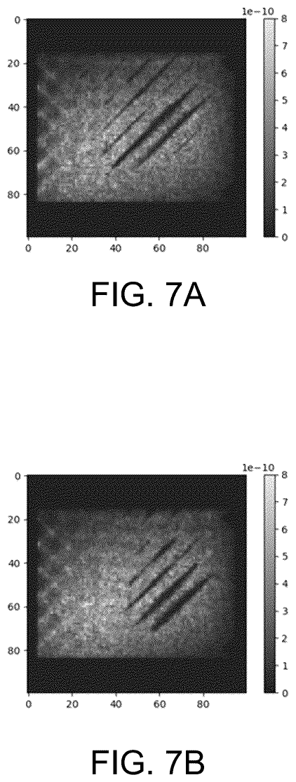

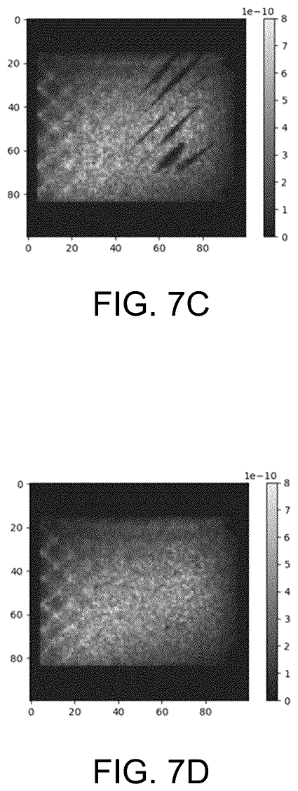

FIG. 7A, FIG. 7B, FIG. 7C, and FIG. 7D each show simulation results of luminance of an image to be formed on the retina of the user's eyes. In FIG. 7, the vertical and horizontal axes represent pixel positions. FIGS. 7A, 7B, 7C, and 7D each show the simulation results of luminance of the image under a plurality of different conditions where the first fill factor of the first reflection region 226 differs.

Conditions other than the first fill factor of the first reflection region 226 will be described. The depth of the first grooves 212 of the incident region 210 is 100 nm or more and 200 nm or less. The length of the IPE period is 350 nm or more and 450 nm or less.

The depth of the second grooves 222 of the first divided regions 224a, 224b, and 224c is 5 nm or more and 100 nm or less. The first period of the first divided regions 224a, 224b, and 224c is 200 nm or more and 300 nm or less. The depth of the second grooves 222 of the first reflection region 226 is 100 nm or more and 700 nm or less. The first period of the second grooves 222 of the first reflection region 226 is 200 nm or more and 300 nm or less.

The depth of the third grooves 232 of the second divided region 234 is 5 nm or more and 100 nm or less. The first period of the third grooves 232 of the second divided region 234 is 350 nm or more and 450 nm or less.

The depth of the third grooves 232 of the second reflection region 236 is 100 nm or more and 700 nm or less. The first period of the third grooves 232 of the second reflection region 236 is 350 nm or more and 450 nm or less. The thickness of the glass substrate 112 is 0.4 mm. The length 248 from the first concave portion 222b to the glass substrate 112 is 100 nm.

FIG. 7A is the simulation results when the first fill factor of the first reflection region 226 is 0.4. FIG. 7B is the simulation results when the first fill factor of the first reflection region 226 is 0.5. FIG. 7C is the simulation results when the first fill factor of the first reflection region 226 is 0.6. FIG. 7D is the simulation results when the first fill factor of the first reflection region 226 is 0.85.

The dark portions in FIGS. 7A, 7B, 7C, and 7D indicate areas where the luminance is low. As shown in FIGS. 7A, 7B, 7C, and 7D, the further the first fill factor of the first reflection region 226 deviates from 0.5, the more that the variation in the luminance across the entire image is reduced, resulting in more uniform luminance. In this way, by forming the second grooves 222 and the third grooves 232 so that the fill factors of the diffraction gratings in the splitting region 220 and the emission region 230 reach appropriate values, luminance unevenness can be reduced.

As described above, the projection substrate 100 according to the present embodiment splits the projection light entering the incident region 210 at different ratios for each of the plurality of first divided regions 224 of the splitting region 220, and emits them as image lights from the emission region 230. By doing this, the projection substrate 100 can reduce variation in the luminance of the projection image to be observed by the user. In addition, the projection substrate 100 can further reduce variation in the luminance of the image by emitting the image light at different ratios for each of the plurality of second divided regions 234 in the emitting region 230.

Such a projection substrate 100 can be realized by forming the diffraction grating corresponding to the incident region 210, the diffraction grating corresponding the splitting region 220, and the diffraction grating corresponding the emission region 230 on the first surface or the second surface of the glass substrate or the like. The grooves forming the diffraction grating are made of resist, resin, or the like, for example. Therefore, the projection substrate 100 according to the present embodiment is a substrate that can be easily produced by forming grooves with predetermined intervals and depths for each region, without incorporating complicated optical systems.

### <Variation Example of the Smart Glasses 10>

Examples of the smart glasses 10, wherein the projection substrate 100 is provided in the frame 110, and the projection part 120 irradiates the incident region 210 of the projection substrate 100 with the projection light have been described above, but the present disclosure is not limited thereto. For example, a plurality of projection substrates 100 may be fixed to the frame 110 of the smart glasses 10. Such smart glasses 10 will now be described.

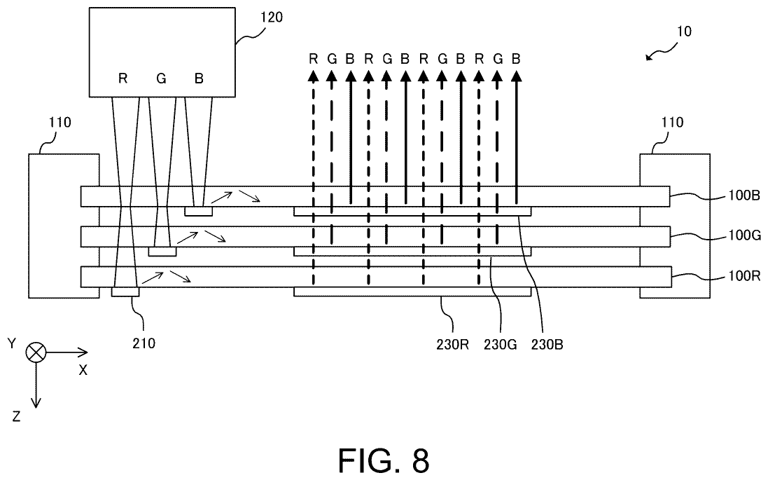

FIG. 8 shows a variation example of the smart glasses 10 according to the present embodiment. In the smart glasses 10 of the variation example, components that are approximately the same as those of the smart glasses 10 according to the present embodiment shown in FIG. 1 are denoted by the same reference numerals, and description thereof is omitted. The appearance of the smart glasses 10 of the variation example may be approximately the same as that of the smart glasses 10 shown in FIG. 1.

A plurality of projection substrates 100 are fixed to the frame 110 of the smart glasses 10 of the variation example. In this configuration, the plurality of projection substrates 100 are fixed to the frame 110 in such a way that emission regions 230, provided on each of the plurality of projection substrates 100, overlap at least partially in a planar view that is approximately parallel to the XY plane. FIG. 8 shows an example in which projection substrates 100R, 100G, and 100B are fixed to the frame 110 of the smart glasses 10, and emission regions 230R, 230G, and 230B of the three projection substrates 100 overlap each other in the planar view in the XY plane.

The projection part 120 radiates projection lights of different wavelengths onto the corresponding incident regions 210 provided on each of the plurality of projection substrates 100, respectively. By doing this, the emission regions 230 provided on each of the plurality of projection substrates 100 respectively emit image light, corresponding to the projection lights respectively radiated onto the plurality of incident regions 210 from the projection part 120, from the second surface of the plurality of projection substrates 100 to the user's eyes.

Since the user wearing such smart glasses 10 observes an image in which the image lights of different wavelengths are superimposed, he/she can observe an image with colors resulting from color mixture. FIG. 8 shows an example in which the projection part 120 radiates three projection lights corresponding to the three primary colors of RGB (such as red, green, and blue), which form an image, to the incident regions 210 of the three projection substrates 100, respectively. Then, the three projection substrates 100 superimpose three image lights corresponding to the three primary colors of RGB and emit the superimposed lights to the user's eyes. By doing this, the user can observe an image having a plurality of colors of 2ⁿ, for example. Here, n is a positive integer such as 4, 8, 16, or 24.

The present disclosure is explained based on the exemplary embodiments. The technical scope of the present disclosure is not limited to the scope explained in the above embodiments and it is possible to make various changes and modifications within the scope of the disclosure. For example, all or part of the apparatus can be configured with any unit which is functionally or physically dispersed or integrated. Further, new exemplary embodiments generated by arbitrary combinations of them are included in the exemplary embodiments. Further, effects of the new exemplary embodiments brought by the combinations also have the effects of the original exemplary embodiments.

What is claimed is:

1. A projection substrate for projecting an image light onto a second surface while transmitting at least a part of light that entered from a first surface to the second surface opposite to the first surface, the projection substrate comprising:
an incident region into which a projection light for projecting the image light enters;
a splitting region that includes a first diffraction grating that guides the projection light that has entered from the incident region; and
an emission region that includes a second diffraction grating that emits a part of the projection light that has entered from the second surface after guiding the part of the projection light entered from the splitting region, wherein
the incident region guides the incident projection light to the splitting region,
the splitting region diffracts the part of the projection light toward the emission region,
the first diffraction grating includes a plurality of first concave-convex portions, each composed of a first convex portion and a first concave portion, that are formed so as to repeat in a first direction in which the projection light is guided,
the splitting region includes a plurality of first divided regions, and
a first fill factor which is a ratio of a width of the first convex portion in the first direction to a length corresponding to a first period, which is a period of the first concave-convex portion in one first divided region, is within a range that does not include a predetermined value, and a first fill factor of a first divided region which is closer to the incident region than the one first divided region is within a range that includes the predetermined value.

2. The projection substrate according to claim 1, wherein
the first period of the first concave-convex portion in each of the plurality of first divided regions is constant.

3. The projection substrate according to claim 1, wherein
the splitting region includes a plurality of divided regions and a reflection region that is provided at a position farthest from the incident region in the splitting region and reflects at least a part of light that has passed through the plurality of divided regions to the plurality of divided regions again.

4. The projection substrate according to claim 1, wherein
a depth of the first concave-convex portion of the one first divided region is greater than a depth of the first concave-convex portion of a first divided region that is closer to the incident region than the one first divided region, and
the greater an absolute value of a difference between the depth of the first concave-convex portion of the one first divided region and the depth of the first concave-convex portion of the first divided region that is closer to the incident region than the one first divided region, the smaller an absolute value of a difference between the first fill factor of the one first divided region and the first fill factor of the first divided region which is closer to the incident region than the one first divided region.

5. The projection substrate according to claim 1, wherein
the predetermined value is 0.5,
the first fill factor of the one first divided region farthest from the incident region among the plurality of first divided regions is within a range of 0.35 or less or 0.65 or more, and
the first fill factor of a first divided region that is closer to the incident region than the one first divided region is within a range of 0.3 or more and 0.7 or less.

6. The projection substrate according to claim 1, wherein
the second diffraction grating includes a plurality of second concave-convex portions, each composed of a second convex portion and a second concave portion, that are formed so as to repeat in a second direction in which the projection light is guided,
the emission region includes a plurality of second divided regions, and
a second fill factor which is a ratio of a width of the second convex portion in the second direction to a length corresponding to a second period, which is a period of the second concave-convex portion in one second divided region which is closer to the splitting region than the one second divided region among the plurality of second divided regions, is within a range that includes the predetermined value.

7. The projection substrate according to claim 6, wherein
the second period of the second concave-convex portion in each of the plurality of second divided regions is constant.

8. The projection substrate according to claim 6, wherein
a depth of the second concave-convex portion of the one second divided region is greater than a depth of the second concave-convex portion of a second divided region which is closer to the splitting region than the one second divided region, and
the greater an absolute value of a difference between the depth of the second concave-convex portion of the one second divided region and the depth of the second concave-convex portion of the second divided region that is closer to the splitting region than the one second divided region, the smaller an absolute value of a difference between (i) a second fill factor which is a ratio of a width of the second convex portion in the second direction to a second period of the second concave-convex portion in the one second divided region and (ii) the second fill factor of the second divided region that is closer to the splitting region than the one second divided region.

9. The projection substrate according to claim 6, wherein
the predetermined value is 0.5,
the second fill factor of the one second divided region is within a range that does not include the predetermined value, and
a second fill factor of a second divided region that is closer to the splitting region than the one second divided region is within a range that includes the predetermined value.

10. The projection substrate according to claim 8, wherein
the predetermined value is 0.5,
the first period of each of the plurality of first divided regions is 50 nm or more and 1 μm or less,
a depth of the first concave-convex portion of the one first divided region is 50 nm or more and 800 nm or less,
the first fill factor of the one first divided region is 0.35 or less or 0.65 or more,
a depth of the first concave-convex portion of a first divided region that is closer to the incident region than the one first divided region is 5 nm or more and 100 nm or less,
the first fill factor of the first divided region that is closer to the incident region than the one first divided region is 0.3 or more and 0.7 or less,
the second period of each of the plurality of second divided regions is 100 nm or more and 1 μm or less,
a depth of the second concave-convex portion of the one second divided region is 50 nm or more and 800 nm or less,
the second fill factor of the one second divided region is preferably 0.35 or less or 0.65 or more,
a depth of the second concave-convex portion in a second divided region that is closer to the splitting region than the one second divided region is 5 nm or more and 100 nm or less, and
a second fill factor of the second divided region that is closer to the splitting region than the one second divided region is 0.3 or more and 0.7 or less.

11. Smart glasses that are worn by a user, the smart glasses comprising:
the projection substrate according to claim 1, which is provided as at least one of a lens for the right eye or a lens for the left eye of the user, and projects the image light onto the second surface, while transmitting at least a part of light entering from the first surface to the eyes of the user;
a frame that fixes the projection substrate; and
a projection part that is provided in the frame and radiates the projection light, for projecting the image light to the emission region onto the incident region of the projection substrate.
